(19) United States
(12) Patent Application Publication
(10) Pub. No.: US 2009/0216792 A1
(43) Pub. Date: Aug. 27, 2009

(54) EMBEDDED WORK PROCESS ITEM MANAGEMENT

(75) Inventors: Olaf Grebner, Haunetal (DE); Ernest Ong, Newtownabbey (GB); Uwe Riss, Karlsruhe (DE)

Correspondence Address: SCHWEGMAN, LUNDBERG & WOESSNER/SAP, P.O. BOX 2938, MINNEAPOLIS, MN, 55402, US

(73) Assignee: SAP AG, Walldorf (DE)

(21) Appl. No.: 12/036,590

(22) Filed: Feb. 25, 2008

(51) Int. Cl. G06F 17/30

(52) U.S. Cl. 707/102; 707/E17.005

(57) ABSTRACT

Apparatus, systems, and methods that operate to automatically extract metadata from information objects are disclosed. Activities may include displaying a journal comprising a plurality of consolidated items, wherein at least some of the plurality of consolidated items have been created based on detecting a first pre-selected operation associated with an information object, and automatically extracting ontology-based metadata related to the first pre-selected operation and native to the information object. Further activities may include modifying an item model ontology including the ontology-based metadata responsive to at least one of user interactions with the journal or automatic creation of a new list item, wherein the new list item is created automatically based on detecting a second pre-selected operation associated with the information object. Additional apparatus, systems, and methods are disclosed.

### BACKGROUND

Knowledge work essentially consists of the organization of information objects on the workstation desktop by Knowledge Workers (KWs), as well as the actual work with these objects. These may be called supporting and production activities, respectively.

It has been found that supporting activities are largely related to Personal Information Management (PIM), which plays a decisive role in knowledge work. Task management (TM) as a supporting activity contributes to PIM since tasks represent a common mechanism used to structure personal work. In the PIM domain, tasks are often organized by emails. Consequently, in the existing literature task management is often discussed in conjunction with email usage as part of PIM.

Unfortunately, current approaches to TM do not provide effective integration with the work context of the KWs and the tools they employ in their daily work. In particular, existing TM software does not efficiently support information management. For example, KWs may be asked to copy and paste information from different application contexts to their TM tools. This results in duplication of information and work, increases the KW cognitive load, and introduces additional administrative overhead for the KW, reducing the relevance and value of TM software to the KW, as well as their motivation to use it.

Semantic web technologies represent an emerging domain in information systems engineering. They also provide a framework to manage, integrate, and locate information, allowing inferences based on semantic annotations, also known as ontology-based metadata. However, when used for the creation of semantic annotations in an enterprise scenario, available solutions are costly. KWs typically invest significant effort to create semantic annotations. This extra maintenance effort, especially when perceived as such, leads to weak acceptance among the workforce.

Finally, KWs often find that TM tools are not closely integrated within the desktop information landscape. This means that access to knowledge artifacts (e.g., documents) from tasks is incomplete. For example, if such access is provided at all, returning to the respective task from the artifact is often not possible.

### BRIEF DESCRIPTION OF THE DRAWINGS

FIG. 1 illustrates an example graphical user interface with a list of consolidated items according to various embodiments of the invention.

FIG. 2 illustrates an example graphical user interface for creating new items according to various embodiments of the invention.

FIG. 3 illustrates an example graphical user interface with item listing, filtering, and relationship details according to various embodiments of the invention.

FIG. 4 is a block diagram illustrating a network of relationships between resources and concepts according to various embodiments of the invention.

FIG. 5 is a block diagram illustrating a process for creating semantic relationships according to various embodiments of the invention.

FIG. 6 is a block diagram of an application sub-system and metadata management sub-system according to various embodiments of the invention.

FIG. 7 is a block diagram of an application sub-system and metadata management sub-system translated into an example application according to various embodiments of the invention.

FIG. 8 is a block diagram of a task sidebar structure according to various embodiments of the invention.

FIG. 9 is a flow diagram illustrating methods of metadata creation according to various embodiments of the invention.

FIG. 10 is a flow diagram illustrating methods of automated item generation according to various embodiments of the invention.

FIG. 11 is a flow diagram illustrating methods of ontology management according to various embodiments of the invention.

FIG. 12 is a block diagram of a machine in the example form of a computer system according to various embodiments of the invention.

### DETAILED DESCRIPTION

The inventors have discovered that the challenges noted above, as well as others, can be addressed using a semantic desktop infrastructure. Ontological models are accessed by plug-in applications, and used to interpret information object activity (e.g., opening an email) to select information object data (e.g., email addressees) that can be automatically extracted as metadata. Items, such as tasks, can be created using the extracted metadata. Existing items can be associated with each other and with the newly-created items using the extracted metadata. In this way, the plug-in applications add item management functionality (e.g., task management) to the information objects themselves by providing automatic metadata extraction, and corresponding item creation according to ontological rules.

A filtered, sorted list of items may be presented in a sidebar displayed on the traditional desktop. Individual items in the sidebar listing can be selected to reveal related resources, including information objects (e.g., web sites, blogs, documents, emails, notes), as well as persons/collaborators, and due dates. Items in the list can have sub-categories. For example, tasks can have sub-tasks.

For the purposes of this document, a “concept” is a thing that represents a user's mental concept stored on a computer. The mental concept is part of a person's cognitive system, and the concept that forms part of an information model can be represented, identified, and visualized on a computer system. The mental concept is grounded in the information model concept.

A “desktop” comprises a graphical user interface that displays icons representing programs, folders, files, and various types of documents (e.g., letters, reports, pictures). The icons on an electronic desktop can be arranged in the same way as real objects are arranged on a real desktop—by moving them around, putting one on top of another, reshuffling them, and throwing them away.

In this document, an “item” may be a task, a goal, an objective, or any concept resulting from KW activity on a computer desktop that comprises an information object related in some way to other information objects on the desktop. From this point onward, it may be noted that the more general term, “item,” will often be replaced by the more specific term, “task.” Those of ordinary skill in the art will realize that the term “item” can be used in each place that the term “task” is used—and that the term “task” represents a more specific implementation of various embodiments by way of example, and not limitation.

A “resource” comprises a web page, a file on a disk, or any manifestation of information inside a computer system. Other examples of resources include address book items, database entries, and calendar appointments.

In various embodiments, item management and semantic web technologies are integrated. This occurs by interweaving human action (as production activity) and knowledge (including semantics) using KW production activities as the primary and seamless mechanism to derive semantic annotations, opening the way to semantically-enabled task management.

The relationships between tasks often result from the fact that activities within or among information objects trigger the creation of tasks. The assumption is that a task usually does not come into being by itself—without having a cause or trigger that is the starting point for the intended activity. Such causes include telephone calls in which work issues are discussed, or information objects that require further processing.

On a desktop, there are numerous information objects that can represent such a cause. For example, a KW might want to follow up on an email as a personal task. Interesting parts of a website, calendar items, or even portions of a text document may also serve as causes of task creation. In an enterprise application scenario, a business object can be such a cause. For example, a purchase order that lacks an approved supplier might lead to the task of gaining approval by the responsible buyer. Colleagues might explicitly delegate tasks, so that an information object is represented by a contact in an address book.

Conversely, a task can also enrich other information objects. For example, when encountering a document, a KW might determine that a task is attached to it. The KW can then go to the attached task to learn more about the document via the relationship.

As an example of some embodiments, a prototypical desktop infrastructure called KASIMIR was developed to provide a workplace-embedded TM that relates tasks to relevant information objects. This infrastructure permits metadata extracted from information objects to be transferred to the triggered (i.e., relevant) tasks. This enables a consolidated view of tasks that unifies task information from different applications. TM is directly integrated into those applications that handle task-relevant information objects. Thus, the KW can perform TM activities directly from these applications. This reduces interruptions of a KW's daily work process.

This kind of integration brings the tasks to the desktop—as opposed to an incidental and administrative overhead—as a work paradigm which allows access and manipulation of tasks from numerous application contexts, without intentional production by the KW. To bring this about, a set of plug-ins for desktop applications and a structured TM application in the form of a sidebar are used. The desktop application plug-ins enable task handling in the context of already existing information objects so that KWs can perform TM using their own well-known environment of existing applications. The sidebar provides a unified list of tasks that responds directly to plug-in activity.

First, to enable systematic TM across application boundaries, the desktop application plug-ins operate to transfer as much information as possible from information objects to tasks. The transferred information may be supplemented by the KW using additional information, if desired. In some embodiments, task creation is effected without any additional effort by the KW. For example, an email plug-in can operate to extract email information to populate task properties accordingly. Thus, the subject of the email can be used as the task name, and selected email content can be used in the task description. The KW can additionally provide other information, e.g., a due date, but is not required to do so for the task to be created.

Second, to reduce interruptions in the normal workflow of the KW, task information can be displayed within the context of the respective PIM application and the information objects therein. The KW can also interact with the displayed task information. For example, a KW is able to see in his email inbox whether a task is attached to an email and what information it carries.

In conjunction with the plug-ins, the TM sidebar enables efficient handling of existing tasks and provides detailed task information. The sidebar can be used to display tasks that emanate from different information objects, providing a consolidated overview for all available tasks on the desktop. This is useful since it avoids overloading plug-ins with TM functionality that KWs do not commonly use in their particular work situation. The TM sidebar closely interacts with the plug-ins, so that the plug-ins can control the TM sidebar remotely. For example, when a KW reads an email related to a task, the TM sidebar shows the details of the particular task as prompted by the plug-in.

Preliminary studies show that email, calendar, and the internet browser are applications where KWs spend most of their working time. In the following, plug-ins for these applications are presented. Thereafter, the TM sidebar is described. It should be noted that plug-ins for other applications can be developed as well, and those describe herein are shown by way of example, and not limitation.

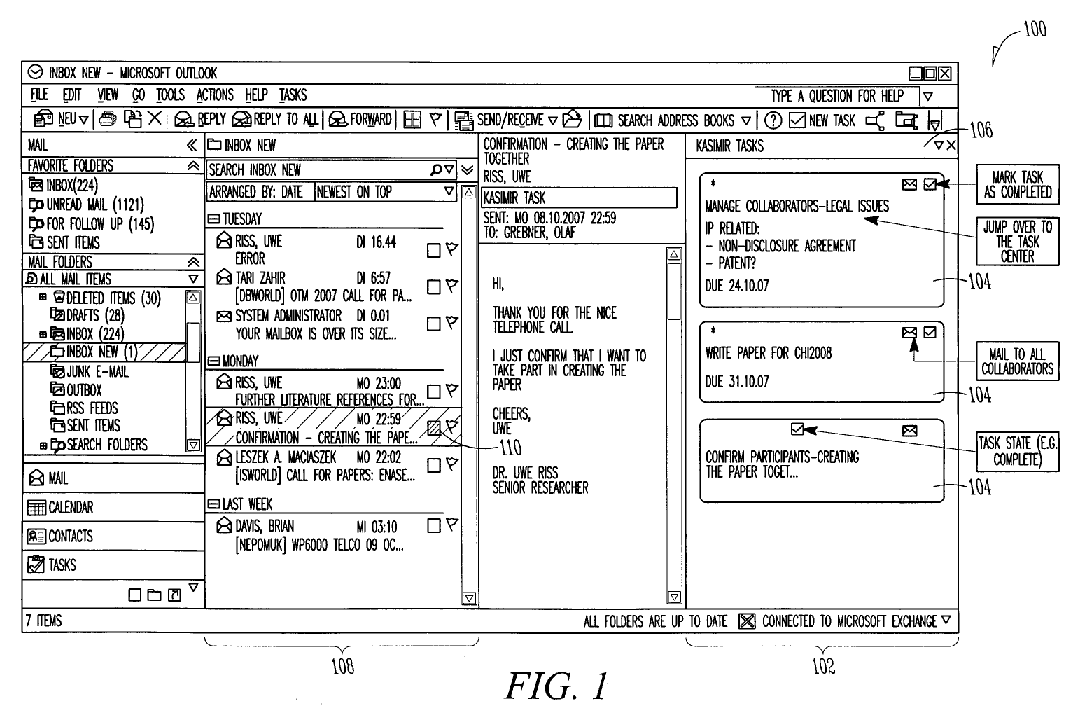

FIG. 1 illustrates an example graphical user interface 100 with a list 102 of consolidated items 104 according to various embodiments of the invention. In this example, the items 104 are shown as tasks in the sidebar 106. To integrate TM with the KW's daily work process in the email client, a Microsoft™ Outlook™ plug-in was developed as part of the KASIMIR prototype.

First, emails 108 are linked to tasks by enabling the KW to create tasks from an email, i.e., triggering tasks from information objects. The email information is used to pre-populate the task with information. For example, the email sender can be added by default as a task observer—as a person interested in the task results, and the subject of the email can be assigned as the task name. This automatic pre-population with email information transforms emails as a part of systematic TM, enabling integrated information management via tasks.

Second, if a task is associated with an email, this can be indicated within the email. In the email inbox such an association is indicated by an icon 110 near the respective email. Further information on the attached tasks is presented with the email. As the task associated with a particular email is selected, the KW sees task details on the task sidebar 106, assisting the KW in understanding the context of the email.

A KASIMIR plug in for the Microsoft™ Outlook™ calendar application operates in a similar fashion. Calendar items can also be related to tasks with due dates and duration. Calendar item information can be transferred to the sidebar 106 by creating a task from the calendar item. Conversely, existing task information can be indicated in conjunction with the calendar item for calendar items that have attached tasks, perhaps using an icon 110.

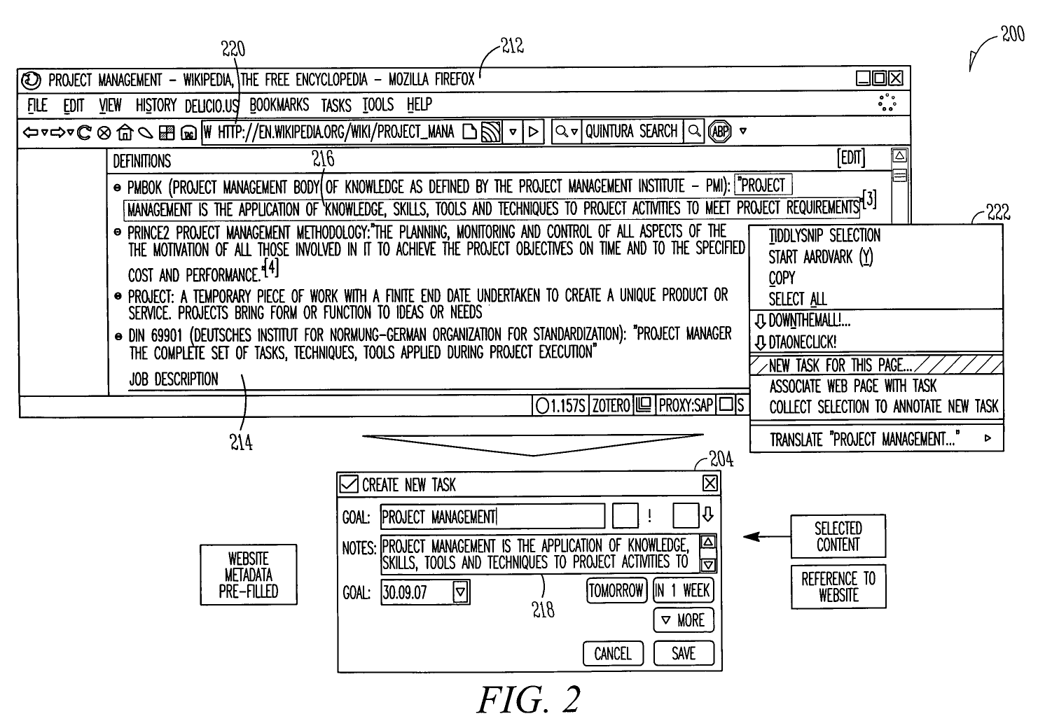

FIG. 2 illustrates an example graphical user interface 200 for creating new items 204 according to various embodiments of the invention. Internet browsers are an almost ubiquitous tool for KWs today. Several tasks can arise when browsing websites, such as when a KW attempts to locate additional resources on a topic, or finds interesting information to share with a colleague in the context of a common task. The KASIMIR internet browser plug-in, which might be used in conjunction with the Mozilla™ Firefox™ browser, includes the functionalities of task creation, and task association.

First, the plug-in can create tasks from a website (or a selection of material taken from a web site), as well as adding website information to previously-existing tasks. For example, when KWs find some information on a website 212 that they want to further consider, a task 204 can be created at this point. The website information 214, or a selection 216 taken from the information 214 is used to pre-populate the task 204. In this case, the selected information 216 is added to the task description 218 and the link 220 to the website 212 is added for further reference. In this way, the website 212 triggering a task 204 is integrated with the TM and can be displayed in the task sidebar.

Second, tasks 204 associated with websites 212 can be shown when the website 212 is displayed in the browser. Associated tasks 204 can also be shown along with selected information 214 within the website 212. When browsing a website 212, the KW is then able to see a list of tasks that comprise the reference to the website 212. This further integrates tasks 204 into the working environment of the KW. The KW can choose to follow up any pending tasks 204 by marking the text as selected information 214 and right-clicking on the selected text to bring up a context menu 222 (provided by the associated plug-in) for selecting “New Task for this page”. Alternatively, the KW can follow up any pending task by adding/appending it to another task. The task sidebar can show further details of the task (as shown in FIG. 1).

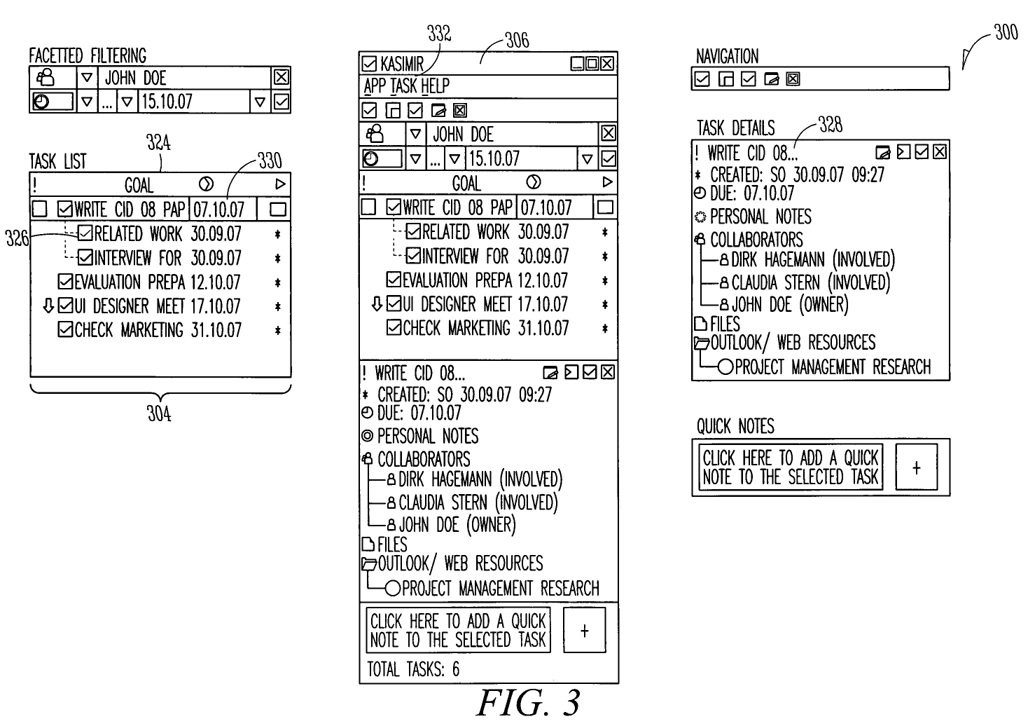

FIG. 3 illustrates an example graphical user interface 300 with item listing, filtering, and relationship details according to various embodiments of the invention. The TM sidebar 306 serves as the front-end of the TM system. The sidebar 306 supplements application plug-ins and enables efficient handling of existing tasks along with the display of detailed task information. KWs can use the task list 324 to gather an overview of their tasks 304. The task list 324 can display tasks 304 and subtasks 326 in several levels of detail. Beneath the task list, the task details 328 shows properties for a single task 330. Basic properties of a task 330, such as task goal, due date, and importance level can be shown along with the task details 328, which is a listing of associated information.

This listing also displays the content of the associated information objects. For example, calendar items open in their default application in order to permit editing. Information objects such as websites, documents and emails are also displayed using the default applications. There are several interaction possibilities for task journal items so that KWs can delete items or see more details.

To better integrate application plug-ins and the TM sidebar 306, the sidebar 306 can be controlled from the application plug-ins. In this way, the sidebar 306 complements the functionality of the application plug-ins, allowing them to remotely trigger the same actions that a user might invoke on the desktop. For example, the “add task” dialogue 332 of the sidebar 306 can be used with different plug-ins to present this dialogue in a unified way across their associated applications.

The KASIMIR prototype is part of a semantic infrastructure that automatically creates semantic annotations within the KW workflow process and across the KW desktop. This semantic network includes a personal information model with concepts and relations between concepts, resources, and desktop information objects that are usable across desktop applications. Desktop resources, such as email messages, files and calendar appointments are physically stored on the desktop. The personal information model represents concepts and their relationships that define the personal knowledge of the KW, e.g. persons and projects.

In the semantic infrastructure, the personal information model can be represented formally by a personal information model ontology (PIMO), known to those of ordinary skill in the art. Readers that desire to learn more about the PIMO are encouraged to consult “PIMO—a PIM Ontology for the Semantic Desktop,” Sauermann, (Draft) Technical Report, DFKI GmbH, 2006.

Resources can be related to concepts by grounding the concepts. This might occur by defining a hasOccurrence relationship to the resource. For example, a person can be grounded by a Microsoft™ Outlook™ contact or a topic can be grounded by a website universal resource locator (URL). More generally, using a PIMO, concepts can also be related, so that a task can be related to a person (i.e., a resource).

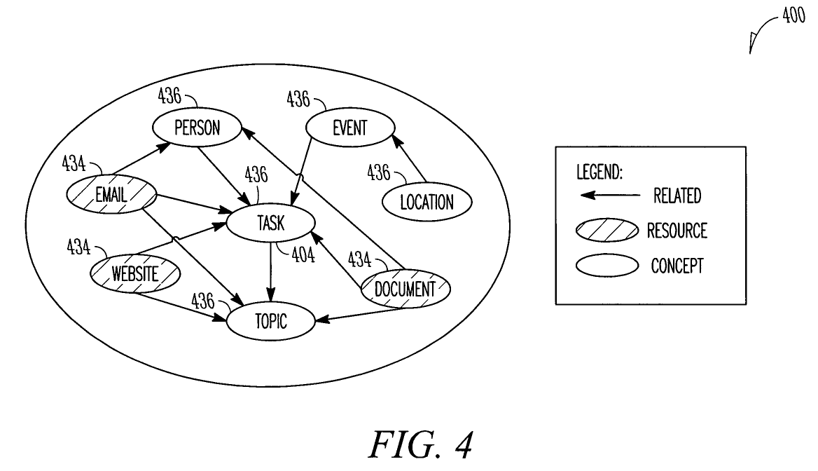

FIG. 4 is a block diagram illustrating a network 400 of relationships between resources 434 and concepts 436 according to various embodiments of the invention. Here it can be seen that an item 404, such as a task, can serve as a hub for PIM and knowledge work organization. The task concept (e.g., item 404) and its relationship to desktop resources 434 and other concepts 436 are shown from a TM point-of-view. This PIMO task concept is extended in various embodiments to define particular relationships of items, concepts, and properties in a TM model so that a task model ontology (TMO) can be used to provide a formalized representation. The TMO serves as an ontology for tasks in the TM infrastructure, and the PIMO is used to relate other concepts and resources.

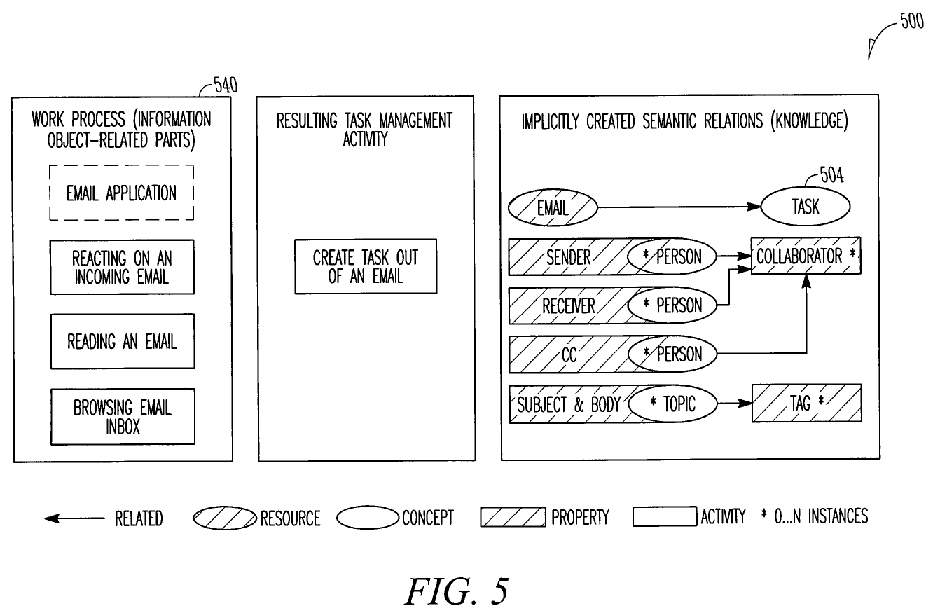

FIG. 5 is a block diagram illustrating a process 500 for creating semantic relationships according to various embodiments of the invention. The KASIMIR prototype is semantically enabled to support the creation of attributes and relations using KW TM activities. However, KASIMIR was not presented to the end-user in the same manner as traditional semantic applications. Instead, KASIMIR was integrated into TM activities via plug-ins and a sidebar, enabling KWs to relate emails, appointments and websites (and their respective concepts) to tasks, all without having the KW explicitly manage the underlying semantics.

When using KASIMIR, KW activity results in semantic annotations made in accordance with the TMO and PIMO. Since the resulting metadata is derived from explicit KW actions, it has a high degree of relevance to the KW. Examples of creating semantic annotations for three common TM activities encountered in the work process (e.g., email usage, calendar usage, and web browsing) follow.

Creating a task from an email message is depicted by the process 500. For example, when a KW opens an incoming email as part of the work process 540, reads an existing email, or even browses through his email inbox, an item 504, such as a task, can be created. Creating a task out of the email, the KW views a pre-populated “add task” dialog and determines which email properties will be added to the task. This leads to the following semantic relations: the email resource is related to the task as an attachment, and the email body defines a topic that describes the task, e.g. using a task tag.

Persons addressed in the email (e.g., obtained from the To, CC, BCC properties or fields) are recommended to the KW as potential task collaborators for the created task. When approved, these persons (represented by the concepts of their names or email addresses) are related to the task. When a person does not already exist as part of the stored metadata, the corresponding concept is created in the PIMO and added as a collaborator to the task.

Creation of tasks based on appointments in a calendar can occur in a similar fashion. Some differences include setting up the related resource as an appointment, instead of an email, and relating an included meeting location to the task.

Web browsing is another activity that can be used to create tasks. Potential semantic relationships include using the website URL as a concept added to the task, and selecting website content for assignment as a topic concept to the task, or to represent task tags. Website content can also be assigned as a location concept to the task, representing a task location.

The KASIMIR environment, which is designed for extensibility, accommodates plug-ins developed to cover additional TM scenarios where tasks can be integrated into further desktop applications. For example, a plug-in for a file manager, such as the Windows™ Explorer™ file manager, can be developed to enable KWs to relate files to a task. Domain ontologies, including information regarding organizational structure and employees, can be added to the PIMO to further leverage existing enterprise knowledge.

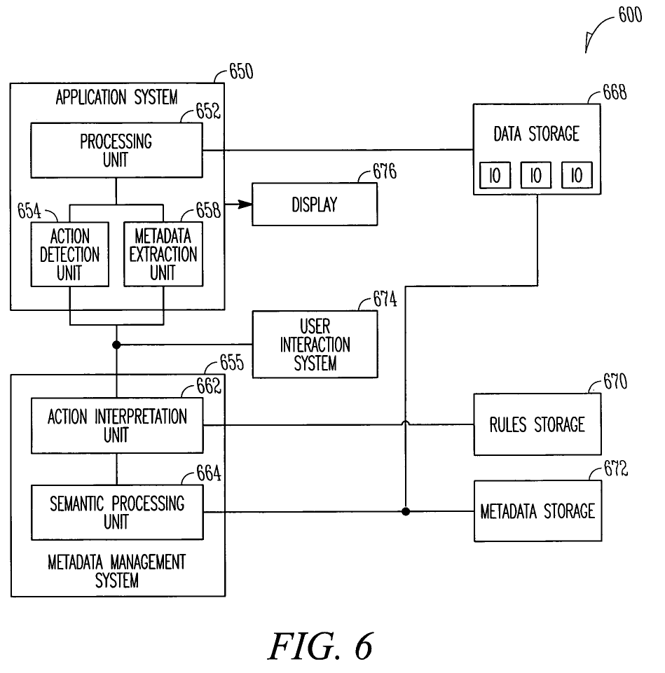

FIG. 6 is a block diagram of an application sub-system 650 and metadata management sub-system 655 according to various embodiments of the invention. These are components of a system 600 that may be used to implement a semantic infrastructure that promotes the automated creation of metadata, as described herein.

The application sub-system 650 includes a processing unit 652, such as applications software and hardware used by a KW to accomplish their work. For example, the processing unit may comprise a personal computer executing a word processing program where a document is written, or a browser where information is located, or an email client used to communicate with others via email messages.

The application sub-system 650 includes an action detection unit 654 that can be realized by an application plug-in. The application plug-in is used to detect which activity a KW is performing and which information objects are affected by this action. A metadata extraction unit 658 extracts data from information objects processed by the application forming a portion of the processing unit 652.

An action interpretation unit 662 may form part of the metadata management sub-system 655. The action interpretation unit 662 uses data extracted from information objects to augment the information provided by the action detection unit 654 according to existing rules. For example, if the application is an email client, the metadata extraction unit 658 might operate to extract sender, subject, etc. from the email opened by a KW. When the action detections unit 654 identifies the action “User creates task from email” the metadata extraction unit 658 can provide this information to enrich the metadata created on the basis of this action. For example, the metadata extraction unit 658 can identify the information object from which the metadata was extracted.

The action interpretation unit 662 operates according to rules stored in external rules storage 670. The action interpretation unit 662 obtains information concerning KW actions from the action detection unit 654 and combines this information with data from the metadata storage 672 according to the specified rules (stored in the external rules storage 670) for the purpose of action interpretation. As a result of this interpretation process, new metadata are generated and/or old metadata is updated.

Information objects 10 affected by KW production activity are stored in data storage 668 external to the application sub-system 650. For example, a “file” information object can be stored as a shared file, and “program code” information objects can be stored in a database.

The metadata management sub-system 655 also includes a semantic processing unit 664 that provides services for the handling metadata. For example, the semantic processing unit 664 can operate to relate metadata stored in the metadata storage 672 with information objects IO in the data storage 668.

The user interaction system 674, coupled to the application sub-system 650 and the metadata management system 655, operates to collect KW feedback. For example, if conflicts in the application of rules occur, or additional information is required for the creation of metadata, the KW can interact with the system 600 via the user interaction system 674. The feedback can be gathered by the system 600 immediately after the triggering user interaction occurs. The system 674 can form part of the same plug-in as the action detection unit 654, or may be included in the system 600 as a completely separate application, perhaps as a sidebar or pop-up window. Thus, many embodiments may be realized.

For example, a system 600 may comprise an application sub-system 650 to detect a first pre-selected operation (e.g., a KW action) associated with an information object. The system 600 may also comprise a metadata management sub-system 655 to automatically extract ontology-based metadata related to the first pre-selected operation and native to the information object. The metadata management sub-system 655 may then operate to modify an item model ontology including the ontology-based metadata responsive to at least one of user interactions with a journal (e.g., editing a sidebar item list) or automatic creation of a new list item. New list items may be created automatically based on detecting a second pre-selected operation (e.g., opening an email) associated with the information object.

In some embodiments, the system 600 may include a display 676 to display a journal comprising a plurality of consolidated items. One or more of the plurality of consolidated items may have been created based on detecting the first pre-selected operation.

The system 600 may comprise rules storage 670 and metadata storage 672 coupled to the metadata management sub-system 655. The metadata management sub-system 655 may comprise an action interpretation unit 662 to augment the ontology-based metadata with information object data according to existing rules. The metadata management sub-system 655 may also comprise a semantic processing unit 664 to relate stored metadata to stored information objects.

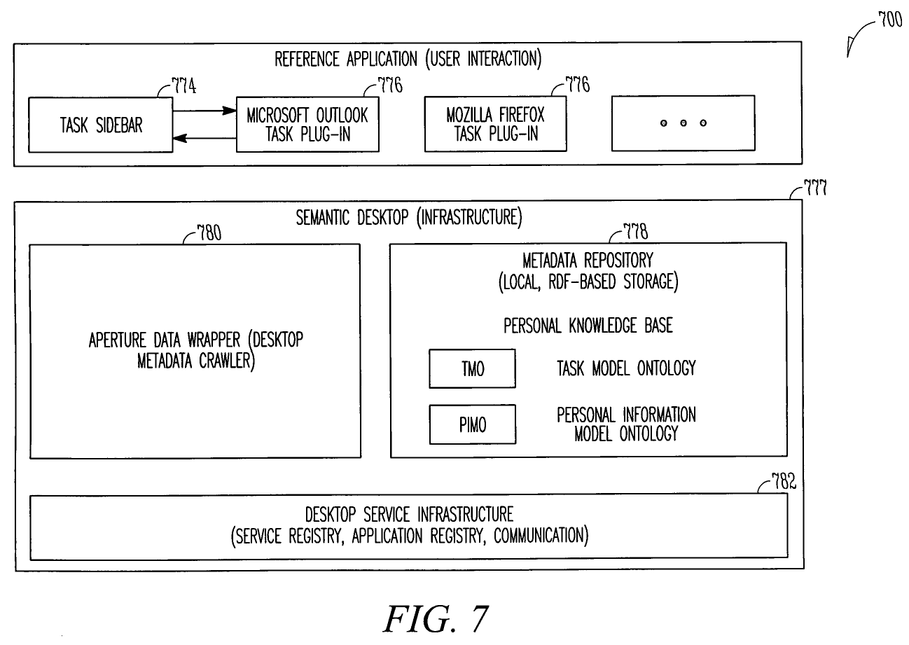

FIG. 7 is a block diagram of an application sub-system and metadata management sub-system translated into an example application according to various embodiments of the invention. Here the system 600 illustrated in FIG. 6 is realized as a specific implementation—to reflect operations of the KASIMIR prototype. Microsoft™ Outlook™ email and calendar software (or any other PIM software, as well as a browser, such as the Mozilla™ Firefox™ browser) may be mapped to the processing unit 652 of FIG. 6. Thus, the KASIMIR prototype includes a task sidebar 774 and plug-ins 776 for Microsoft™ Outlook™ software, as well as the Mozilla™ Firefox™ browser. A semantic infrastructure 777 is provided as middleware. In this way, resources and the personal information model can be managed efficiently, along with their formal representations.

For the KASIMIR prototype, a variety of middleware components permit rooting system operations in semantic web technologies. The local storage 778 can include a resource description framework (RDF) repository. The repository can provide the semantic database for all semantic annotations, including tasks and other concepts, such as persons, and ontologies, including a PIMO and TMO. Here it can be seen that the local storage 778 maps to the corresponding rules storage 670 and metadata storage 672 of FIG. 6.

The aperture data wrapper 780 actively crawls the desktop searching for information objects such as emails, documents, and spreadsheets. When such objects are found, their semantic annotations are added to the RDF repository. The desktop service infrastructure 782 acts as a service and application registry for semantically-enabled services and enables communication between them. In particular, communication between the sidebar 774 and local storage 778 is enabled.

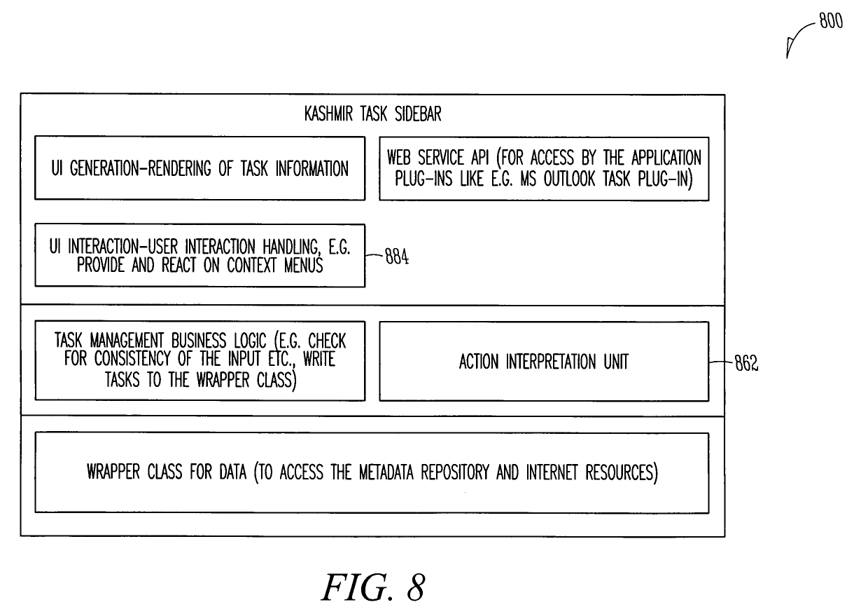

FIG. 8 is a block diagram of a task sidebar 800 structure according to various embodiments of the invention. The task sidebar 800 is shown as implemented in the KASIMIR prototype. Here it can be seen that the action interpretation unit 862 maps to the corresponding action interpretation unit 662 of FIG. 6. The UI interaction unit 884 maps to the action detection unit 654 and metadata extraction unit 658 of FIG. 6.

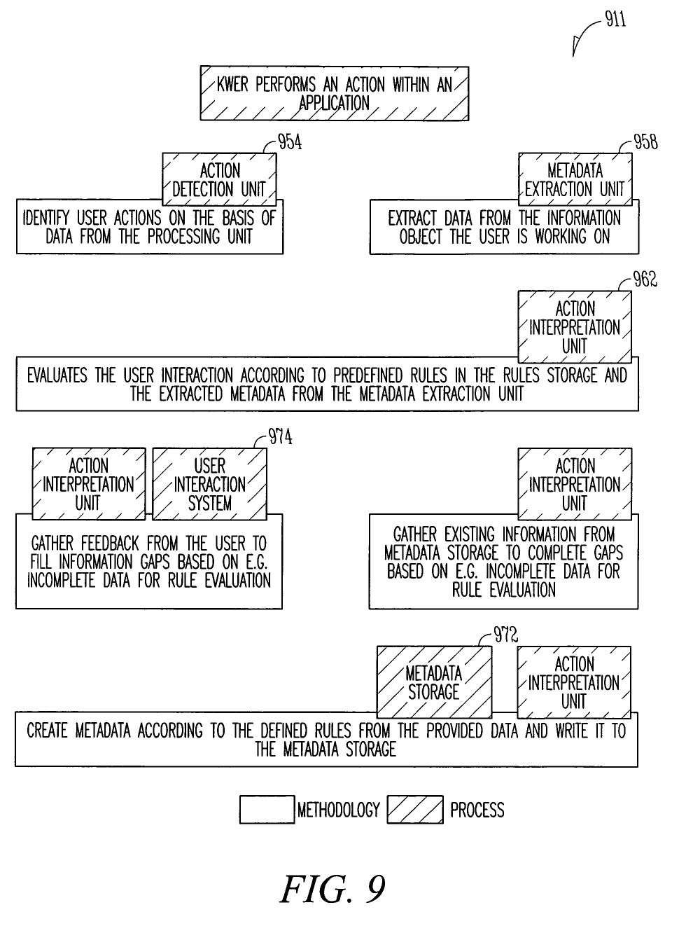

FIG. 9 is a flow diagram illustrating methods 911 of metadata creation according to various embodiments of the invention. Here it can be seen how KW actions are interpreted to automatically create metadata. The processes shown in FIGS. 6-8 are identified, along with the methodology they execute. Some example embodiments will now be outlined.

Consider a KW using a word processor to edit a document text.doc. During this activity the KW creates a task. The action detection unit 954 realized as a plug-in detects this activity and sends the information “user has started a task T1” to the action interpretation unit 962. The action interpretation unit 962 is also aware that the KW is working on a document and that this document is identified as is text.doc according to the specified actions that the action detection unit 954 sends to the action interpretation unit 962.

If a new event is transferred from the action detection unit 954 to the action interpretation unit 962, the latter accesses rule storage to determine whether any rule is applicable in this particular situation. A rule may be located in the rule storage that says: IF “the KW is working on a document text.doc” AND “the KW creates a task T1” THEN “create a semantic relationship ‘document is relevant’ between the representation of the text.doc and the task T1 in the metadata storage.” In this case, the net effect is that metadata are created implicitly, while the KW executes a normal workflow (e.g., creating a task), without any explicit effort on the part of the KW.

As another example, consider a KW creating a task from an email message. The action detection unit 954 operates to detect creation of the task, and the metadata extraction unit 958 operates to extract the email content, such as the identity and/or address of the sender, the identity and/or address of the receiver, the subject, and the body. The action interpretation unit 962 can then operate to resolve semantic representations by locating the email sender/receivers and related personnel in the semantic database. The email reference may also be resolved in the semantic database. At this point, initial task metadata with related representations of persons and emails can be created according to rules stored in the rule storage.

The action interpretation unit 962 and the user interaction system 974 can operate together to request confirmation of participating persons by the KW, filling in the information gaps. The action interpretation unit 962 can also operate to gather further email-related information to enrich the created task, such as documents or other items attached to the email. Finally, the initial task metadata, along with additional metadata created as a result of confirmation and additional gathering activity, are stored in the metadata storage 972. These are but two examples of how various embodiments described herein can operate, and they are given for purposes of illustration, and not limitation. Thus, many embodiments may be realized.

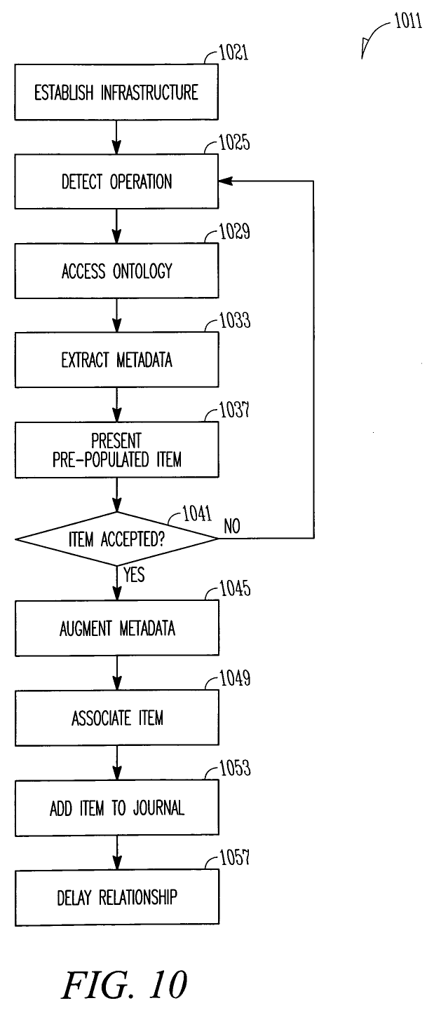

For example, FIG. 10 is a flow diagram illustrating methods 1011 of automated item generation according to various embodiments of the invention. The methods 1011 are implemented in a machine-accessible and readable medium, and are operational over processes within and among networks. The networks may be wired, wireless, or a combination of wired and wireless. The methods 1011 may be implemented as instructions, which when accessed by a machine, perform the processing depicted in FIGS. 1-9. Given this context, embedded work process item management is now discussed with reference to FIG. 10.

In some embodiments, a computer-implemented method 1011 of automatically extracting item-based metadata, such as task metadata, may begin at block 1021 with establishing a desktop service infrastructure to enable communications between an item model ontology and a journal, or list of items. The item model ontology may comprise a task model ontology, among others. The desktop service infrastructure may also be established to enable communications between a repository (e.g., an RDF repository) that includes the item model ontology and a program module plug-in to one or more information objects. As noted previously, information objects include emails, files, documents, notes, blogs, web sites, web site elements, calendars, and calendar appointments, among others.

The method 1011 may include detecting a pre-selected operation (e.g., viewing an email) associated with an information object to initiate creation of a new list item at block 1025. The method 1011 may go on to block 1029 to include accessing the item model ontology to interpret the pre-selected operation to determine the ontology-based metadata to be automatically extracted. That is, the ontology determines which data can be automatically extracted.

In most embodiments, the method 1011 includes, at block 1033, automatically extracting ontology-based metadata related to the operation and native to the information object. For example, the automatic extraction may comprise non-interactively extracting the ontology-based metadata using a program module plug-in to the information object.

The method 1011 may go on to block 1037, with presenting the new list item pre-populated with at least a first portion of the ontology-based metadata. This activity may include displaying the new list item comprising at least one of a pre-existing list item name, list item content, or list item collaborator, or any other selected information. For example, a new task can be displayed, comprising at least one of a pre-existing task name, task content, or task collaborator.

If the new list item is accepted, as determined at block 1041, then upon receiving acceptance of the new list item, the method 1011 may include, at block 1045, augmenting the second portion of the ontology-based metadata with input from a user (e.g., KW) interacting with the information object prior to adding the second portion of the ontology-based metadata to the item model ontology. This activity permits a KW to add metadata in a non-automated fashion, as desired.

In some embodiments, the method 1011 may include, at block 1049, automatically associating the new list item with an existing list item. In this way, one item can be automatically associated with another, perhaps based on a mutually-related information object. For tasks, the new task can be automatically associated with an existing task.

The method 1011 may go on to include adding the new list item to a user item journal, and adding at least a second portion of the ontology-based metadata to an item model ontology at block 1053.

The methods 1011 outlined can be oriented more specifically to tasks, so that the activities outlined can include: detecting a pre-selected operation associated with an information object to initiate creation of a new task, automatically extracting ontology-based metadata related to the operation and native to the information object, presenting the new task pre-populated with at least a first portion of the ontology-based metadata, and upon receiving acceptance of the new task, adding the new task to a user task journal and adding at least a second portion of the ontology-based metadata to a task model ontology.

The method 1011 may include, in some embodiments, displaying the new list item as one of a plurality of consolidated items, wherein the new list item is displayed in relationship to the information object, at block 1057. Thus, items, such as tasks, may be listed as a group, with indications of relationships to their associated information objects. The items can also be displayed in relationship to each other, so that the activity at block 1057 may include displaying the new list item as one of a plurality of consolidated items, wherein the new list item is displayed in relationship to at least one of the plurality of consolidated items. Still further embodiments may be realized.

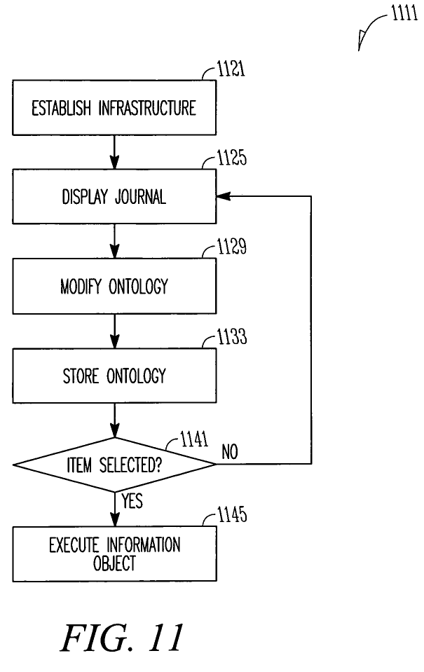

For example, FIG. 11 is a flow diagram illustrating methods 1111 of ontology management according to various embodiments of the invention. The methods 1111 are implemented in a machine-accessible and readable medium, and are operational over processes within and among networks. The networks may be wired, wireless, or a combination of wired and wireless. The methods 1111 may be implemented as instructions, which when accessed by a machine, perform the processing depicted in FIGS. 1-9. Given this context, embedded work process item management is now discussed with reference to FIG. 11.

In some embodiments, a computer-implemented method 1111 of maintaining an item model ontology, such as a task model ontology, may begin at block 1121 with establishing a desktop service infrastructure to enable communications between an item model ontology and a journal, or list of items. The item model ontology may comprise a task model ontology, among others. The desktop service infrastructure may also be established to enable communications between a repository (e.g., an RDF repository) that includes the item model ontology and a program module plug-in to one or more information objects.

The method 1111 may include displaying a journal comprising a plurality of consolidated items at block 1125, wherein at least some of the plurality of consolidated items have been created based on detecting a first pre-selected operation associated with an information object. Displaying the journal may occur in conjunction with automatically extracting ontology-based metadata related to the first pre-selected operation and native to the information object.

The journal may be displayed as a desktop sidebar to be remotely controlled by at least one program module plug-in to the information object. The journal may also be displayed as a filtered, sorted list of the plurality of consolidated items (e.g., tasks), wherein individual ones of the plurality of consolidated items can be selected to reveal related resources, which may comprise information objects and personal identities, among others. Ontology-based metadata might comprise a pre-existing URL address or a portion of content referenced by the URL address, among others.

In most embodiments, the method 1111 includes, at block 1129, modifying an item model ontology (and/or task model ontology) including the ontology-based metadata responsive to user interactions with the journal, automatic creation of a new list item, or both. The new list item is created automatically based on detecting a second pre-selected operation associated with the information object. The item model ontology is used to define relationships between the new list item and the associated information object, the plurality of consolidated items, or both. Tasks can be related in a similar fashion. Thus, a list of items can be displayed as a result of automatically extracted metadata used to pre-populate information associated with the items, and the ontology can be changed to reflect the newly-created items, or interactions with the list.

The method 1111 may go on to include storing the item ontology model in an RDF repository at block 1133. In some embodiments, the ontology model may comprise a task ontology model. If the selection of an item is received at block 1141, then the method 1111 may include receiving a selection of one of the plurality of consolidated items, and executing an information object related to the selection at block 1145 (e.g., opening a related spreadsheet). Executing information objects related to items, such as tasks selected from the sidebar, enables the KW to effectively integrate TM into normal workflow activities.

Those of ordinary skill in the art will realize that each of the method elements shown in FIG. 11 may be added to or substituted for any of the method elements shown in FIGS. 9-10. Additionally, those of ordinary skill in the art will also realize that each of the method elements of FIGS. 9-11 may be combined with the others in a variety of ways, to form a variety of methods that use the elements from each of the figures in serial, parallel, looped, and/or repetitious fashion.

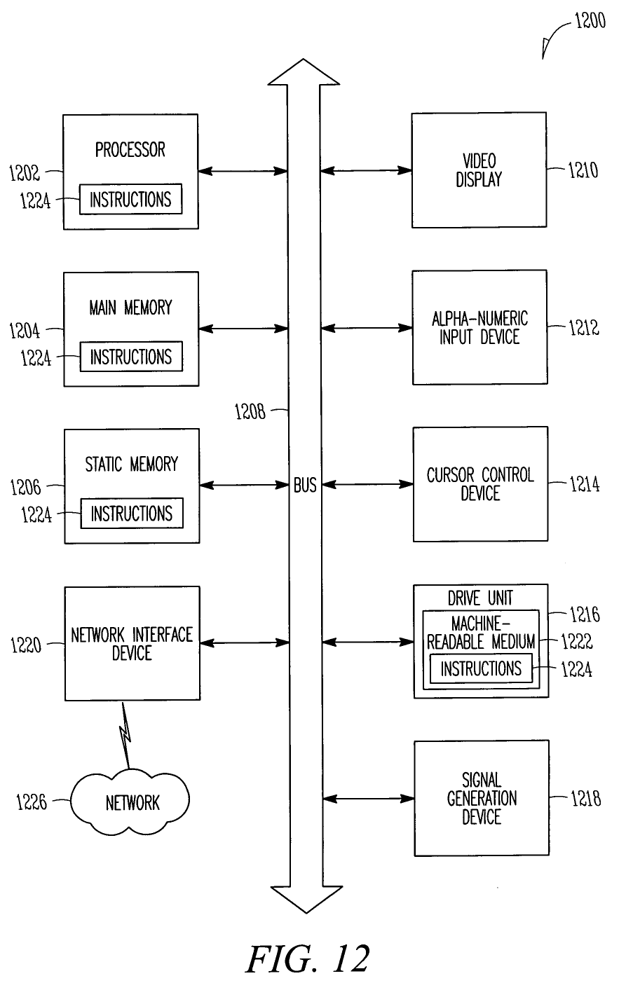

FIG. 12 is a block diagram of a machine in the example form of a computer system 1200 according to various embodiments of the invention. The computer system may include a set of instructions 1224 for causing the system 1200 to perform any one or more of the methodologies discussed herein, including those illustrated in FIGS. 9-11. The system 1200 may be similar to or identical to the system 600 of FIG. 6.

In some embodiments, the system 1200 may operate as a standalone device or may be connected (e.g., networked) to other machines. In a networked deployment, the system 1200 may operate in the capacity of a server or a client machine in a server-client network environment, or as a peer machine in a peer-to-peer (or distributed) network environment.

The system 1200 may comprise a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 may include a processor 1202 (e.g., a central processing unit (CPU), a graphics processing unit (GPU) or both), a main memory 1204 and a static memory 1206, all of which communicate with each other via a bus 1208. The computer system may further include a video display unit 1210 (e.g., liquid crystal displays (LCD) or cathode ray tube (CRT)). The display unit 1210 may be used to display a GUI according to the embodiments described with respect to FIGS. 1-3. The computer system 1200 also may include an alphanumeric input device 1212 (e.g., a keyboard), a cursor control device 1214 (e.g., a mouse), a disk drive unit 1216, a signal generation device 1218 (e.g., a speaker), and a network interface device 1220.

The disk drive unit 1216 may include a machine-readable medium 1222 on which is stored one or more sets of instructions (e.g., software 1224) embodying any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media. The software 1224 may further be transmitted or received over a network 1226 via the network interface device 1220, which may comprise a wired and/or wireless interface device.

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include tangible media that include, but are not limited to, solid-state memories, optical, and magnetic media.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information).

In conclusion, it can be seen that the semantic infrastructure presented herein allows KWs to perform TM activities within the familiar environment of desktop applications. Moreover, semantic annotations are implicitly created out of common KW activities, so that a consolidated overview of items across application boundaries can be provided. Since the applications are highly integrated, the impact on the KW workflow is reduced, and the cost of metadata creation is lowered. The cutting-edge use social semantic technology to efficiently relate objects, coupled with direct and automatic extraction of metadata, provides the potential for increased KW satisfaction and productivity.

Embodiments of the invention can be implemented in a variety of architectural platforms, operating and server systems, devices, systems, or applications. Any particular architectural layout or implementation presented herein is thus provided for purposes of illustration and comprehension only, and is not intended to limit the various embodiments.

The Abstract of the Disclosure is provided to comply with 37 C.F.R. § 1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A computer implemented method, comprising:
detecting a pre-selected operation associated with an information object to initiate creation of a new list item;
automatically extracting ontology-based metadata related to the operation and native to the information object;
presenting the new list item pre-populated with at least a first portion of the ontology-based metadata; and
upon receiving acceptance of the new list item, adding the new list item to a user item journal and adding at least a second portion of the ontology-based metadata to an item model ontology.

2. The method of claim 1, wherein the information object comprises at least one of an email, a web site, a web site element, a calendar, or a text document.

3. The method of claim 1, comprising:
augmenting the at least a second portion of the ontology-based metadata with input from a user interacting with the information object prior to adding the at least a second portion of the ontology-based metadata to the item model ontology.

4. The method of claim 1, wherein automatically extracting comprises:
accessing the item model ontology to interpret the pre-selected operation to determine the ontology-based metadata to be automatically extracted.

5. The method of claim 1, wherein automatically extracting comprises:
extracting the ontology-based metadata using a program module plug-in to the information object.

6. The method of claim 1, wherein presenting the new list item pre-populated with at least a first portion of the ontology-based metadata comprises:
displaying the new list item comprising at least one of a pre-existing list item name, list item content, or list item collaborator.

7. The method of claim 1, comprising:
displaying the new list item as one of a plurality of consolidated items, wherein the new list item is displayed in relationship to the information object.

8. The method of claim 1, comprising:
displaying the new list item as one of a plurality of consolidated items, wherein the new list item is displayed in relationship to at least one of the plurality of consolidated items.

9. The method of claim 1, comprising:
automatically associating the new list item with an existing list item.

10. A computer implemented method, comprising:
displaying a journal comprising a plurality of consolidated items, wherein at least some of the plurality of consolidated items have been created based on detecting a first pre-selected operation associated with an information object, and automatically extracting ontology-based metadata related to the first pre-selected operation and native to the information object; and
modifying an item model ontology including the ontology-based metadata responsive to at least one of user interactions with the journal or automatic creation of a new list item, wherein the new list item is created automatically based on detecting a second pre-selected operation associated with the information object.

11. The method of claim 10, wherein the item model ontology is to define relationships between the new list item and at least one of the information object or the plurality of consolidated items.

12. The method of claim 10, wherein the journal is displayed as a desktop sidebar to be remotely controlled by at least one program module plug-in to the information object.

13. The method of claim 10, wherein the journal is displayed as a filtered, sorted list of the plurality of consolidated items, and wherein individual ones of the plurality of consolidated items can be selected to reveal related resources.

14. The method of claim 13, comprising:
receiving a selection of one of the plurality of consolidated items; and
executing an information object related to the selection.

15. The method of claim 13, wherein the resources comprise at least one of information objects and personal identities.

16. The method of claim 10, wherein the ontology-based metadata comprises:
at least one of a pre-existing universal resource locator (URL) address or a portion of content referenced by the URL address.

17. The method of claim 10, comprising:
storing the item ontology model in a resource description framework (RDF) repository.

18. A computer readable medium having instructions stored therein for causing a computer to implement a method, comprising:
displaying a journal comprising a plurality of consolidated items, wherein at least some of the plurality of consolidated items have been created based on detecting a first pre-selected operation associated with an information object, and automatically extracting ontology-based metadata related to the first pre-selected operation and native to the information object; and
modifying an item model ontology including the ontology-based metadata responsive to at least one of user interactions with the journal or automatic creation of a new list item, wherein the new list item is created automatically based on detecting a second pre-selected operation associated with the information object.

19. The medium of claim 18, wherein the method comprises:
establishing a desktop service infrastructure to enable communications between the item model ontology and the journal.

20. The medium of claim 18, wherein the method comprises:
establishing a desktop service infrastructure to enable communications between a repository that includes the item model ontology and a program module plug-in to the information object.

21. A system, comprising:
an application sub-system to detect a first pre-selected operation associated with an information object; and
a metadata management sub-system to automatically extract ontology-based metadata related to the first pre-selected operation and native to the information object, and to modify an item model ontology including the ontology-based metadata responsive to at least one of user interactions with a journal or automatic creation of a new list item, wherein the new list item is created automatically based on detecting a second pre-selected operation associated with the information object.

22. The system of claim 21, comprising:
a display to display a journal comprising a plurality of consolidated items, wherein at least some of the plurality of consolidated items have been created based on detecting the first pre-selected operation.

23. The system of claim 21, comprising:
rules storage and metadata storage coupled to the metadata management sub-system.

24. The system of claim 21, wherein the metadata management sub-system comprises:
an action interpretation unit to augment the ontology-based metadata with information object data according to existing rules.

25. The system of claim 21, wherein the metadata management sub-system comprises:
a semantic processing unit to relate stored metadata to stored information objects.
